(19) United States
(12) Patent Application Publication
(10) Pub. No.: US 2022/0271383 A1
(43) Pub. Date: Aug. 25, 2022

(54) BATTERY MODULE

(71) Applicant: HONDA MOTOR CO., LTD., Tokyo (JP)

(72) Inventors: Shigemitsu AKUTSU, Saitama (JP); Shinji FUJIMOTO, Saitama (JP)

(21) Appl. No.: 17/578,457

(22) Filed: Jan. 19, 2022

(30) Foreign Application Priority Data
Feb. 19, 2021 (JP) 2021-025554

(51) Int. Cl. H01M 50/264; H01M 50/211; H01M 10/04; H01M 50/249

(52) U.S. Cl. CPC H01M 50/264; H01M 50/211; H01M 10/0481; H01M 50/249; H01M 2220/20

(57) ABSTRACT

Provided is a battery module in which torsion residual stress in a rod-shaped connecting member that fastens end plates is minimized so that looseness of the end plate fastening member can be prevented during use. A battery module in which a stacked body of a plurality of battery cells is pinched and held by two end plates from both end sides in a stacking direction, includes a rod-shaped connecting member. The rod-shaped connecting member applies tension in directions opposite to each other to the two end plates on both the end sides. The rod-shaped connecting member includes fastening portions adjacent to one end plate, and includes a detent mechanism part in the vicinity of the fastening portions.

This application is based on and claims the benefit of priority from Japanese Patent Application No. 2021-025554, filed on 19 Feb. 2021, the content of which is incorporated herein by reference.

### BACKGROUND OF THE INVENTION

### Field of the Invention

The present invention relates to a battery module serving as a power source for a motor-driven vehicle or the like.

### Related Art

In order to allow a battery module serving as a power source of a motor-driven vehicle or the like to function appropriately, it is necessary to apply pressure to stacked battery cells in the stacking direction to pressurize them. According to a known pressurizing method, end fixing members (end plates) are provided on both end faces of a stacked body of battery cells, and the end fixing members are fastened with a plurality of bolts or bolts and nuts, whereby a surface pressure load is applied to the battery cells. In general, torsion residual stress caused by friction on a thread surface remains in the bolt shaft portion. Further, since a longer bolt shaft is required in proportion to the dimension in the stacking direction of the battery cells in a battery module, the residual displacement quantity (torsion angle) in the screw shaft portion becomes larger. Thus, looseness is likely to be caused by vibration or temperature change. Moreover, when the torsion residual stress exists throughout the entire shaft length of the screw shaft portion, the effective strength of the shaft portion is lowered. Furthermore, in order to prevent looseness or the like, a lot of management labor is required to reduce and stabilize the friction on the thread surface. Meanwhile, a technique of providing a detent to a restraint rod connecting end plates has been proposed (for example, see Patent Document 1).
Patent Document 1: Japanese Patent No. 4136328

### SUMMARY OF THE INVENTION

According to the technique of Patent Document 1, while a battery module is assembled, when restraint rod is fastened with a bolt, deterioration of workability due to rotation of the restraint rod along with rotation of the bolt can be suppressed. However, the technique of Patent Document 1 is not for preventing looseness of bolts and nuts fastening end plates during use of the battery module. That is, since no countermeasure is taken for torsion residual stress that is caused by friction on the thread surface at the time of fastening and remains in the bolt shaft portion, it is impossible to prevent looseness of bolts and nuts during use. Moreover, according to the technique of Patent Document 1, it is not supposed to provide detents at both ends in a case of fastening bolts and nuts at both ends.

The present invention has been made in view of the aforementioned situation. An object of the present invention is to provide a battery module which can prevent looseness of a rod-shaped member that fastens end plates during use, by minimizing torsion residual stress in the rod-shaped connecting member.

(1) A battery module in which a stacked body of a plurality of battery cells is pinched and held by two end plates from both end sides in a stacking direction, the battery module including a rod-shaped connecting member applying tension in directions opposite to each other to the two end plates on both the end sides, the rod-shaped connecting member including a fastening portion adjacent to one of the two end plates, and including a detent mechanism part in a vicinity of the fastening portion.

(2) In the battery module according to (1), one of the two end plates, which is away from the fastening portion of the rod-shaped connecting member, includes a spigot joint portion that is coaxial with the detent mechanism part.

(3) In the battery module according to (1), the rod-shaped connecting member has a smaller diameter in an intermediate portion in a longitudinal direction than in an end portion.

In the battery module according to (1), the rod-shaped connecting member includes the fastening portion adjacent to one of the two end plates, and the detent mechanism part in the vicinity of the fastening portion. Therefore, at the time of fastening operation, the residual torsion (torsion stress) in the fastening portion is generated limitedly in a section corresponding to the vicinity described above. On the other hand, a major section of the entire length of the rod-shaped connecting member, from the detent mechanism part of the rod-shaped connecting member to the other end plate side, is not affected by displacement around the shaft from the other end plate side. Accordingly, the major section of the entire length of the rod-shaped connecting member has no residual torsion. As a result, it is possible to prevent looseness of the fastening portion of the rod-shaped connecting member during use of the battery module.

In the battery module according to (2), one of the two end plates, which is away from the fastening portion of the rod-shaped connecting member, includes a spigot joint portion that is coaxial with the detent mechanism part. Therefore, the shaft center position of the rod-shaped connecting member is held at a normal position.

In the battery module according to (3), the rod-shaped connecting member has a smaller diameter in the intermediate portion in the longitudinal direction than in the end portion. Therefore, the weight of the rod-shaped connecting member can be reduced.

### BRIEF DESCRIPTION OF THE DRAWINGS

FIG. 1 is a plan view of a battery module according to a first embodiment of the present invention;

FIG. 2 is a side view of the battery module of FIG. 1;

FIG. 3 illustrates the battery module of FIG. 1 as viewed from one end plate side;

FIG. 4 illustrates the battery module of FIG. 1 as viewed from the other end plate side;

FIG. 5 illustrates a part surrounded by a circle C in FIG. 1 in an enlarged manner;

FIG. 6 is a cross-sectional view taken along line A-A in FIG. 5;

FIG. 7 illustrates the elements in FIG. 6 separately;

FIG. 8 is a cross-sectional view taken along line B-B in FIG. 5;

FIG. 9 illustrates the elements in FIG. 8 separately;

FIG. 10 illustrates a main part of a battery module as a second embodiment of the present invention;

FIG. 11 is a cross-sectional view taken along line A-A in FIG. 10;

FIG. 12 illustrates the elements in FIG. 11 separately;

FIG. 13 is a cross-sectional view taken along line B-B in FIG. 10;

FIG. 14 illustrates the elements in FIG. 13 separately;

FIG. 15 illustrates surroundings of a detent mechanism in FIG. 10 in an enlarged manner;

FIG. 16 illustrates a main part of a battery module as a third embodiment of the present invention;

FIG. 17 is a cross-sectional view taken along line A-A in FIG. 16;

FIG. 18 illustrates the elements in FIG. 17 separately;

FIG. 19 is a cross-sectional view taken along line B-B in FIG. 16;

FIG. 20 illustrates the elements in FIG. 19 separately;

FIG. 21 illustrates a main part of a battery module as a fourth embodiment of the present invention;

FIG. 22 is a cross-sectional view taken along line A-A in FIG. 21;

FIG. 23 illustrates the elements in FIG. 22 separately;

FIG. 24 is a cross-sectional view taken along line B-B in FIG. 21;

FIG. 25 illustrates the elements in FIG. 24 separately;

FIG. 26 illustrates a main part of a battery module as a fifth embodiment of the present invention;

FIG. 27 is a diagram for explaining dynamic characteristics of the present invention in comparison with a conventional example; and

FIG. 28 illustrates a configuration of the conventional example compared in FIG. 27.

### DETAILED DESCRIPTION OF THE INVENTION

### First Embodiment

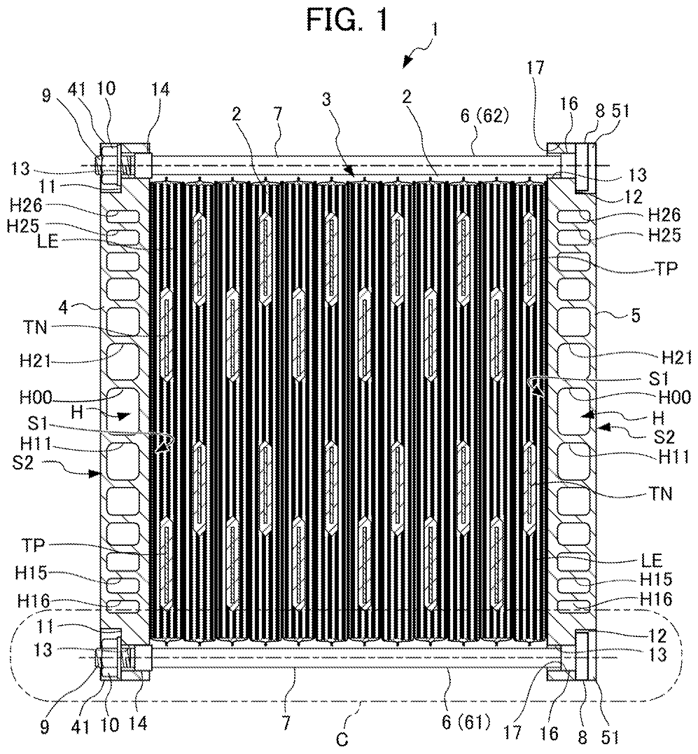

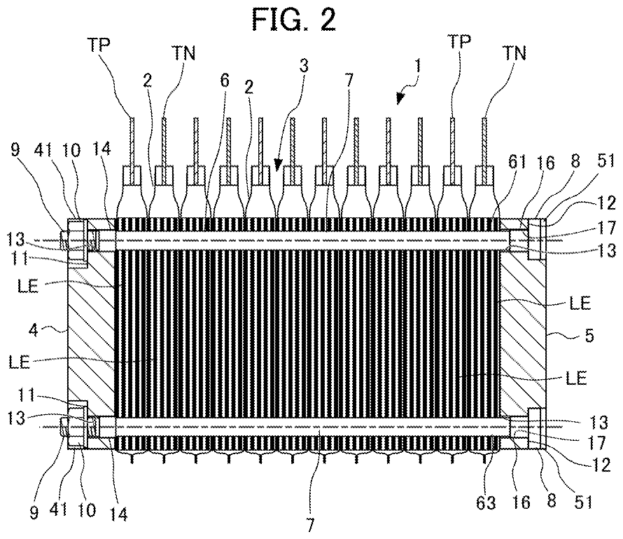

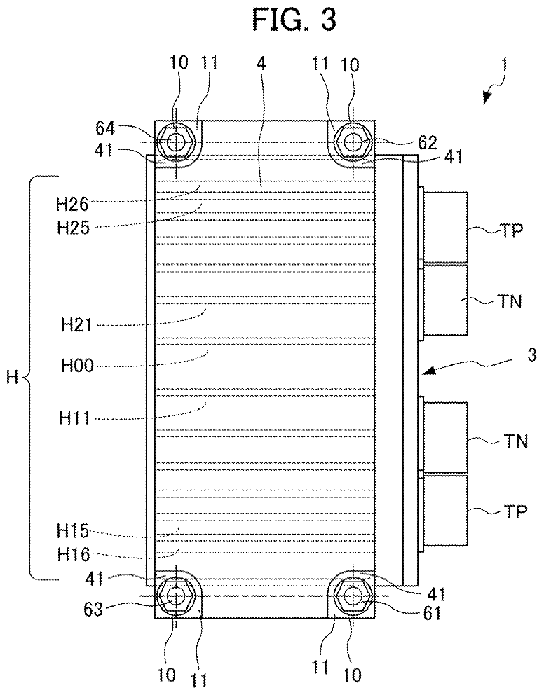

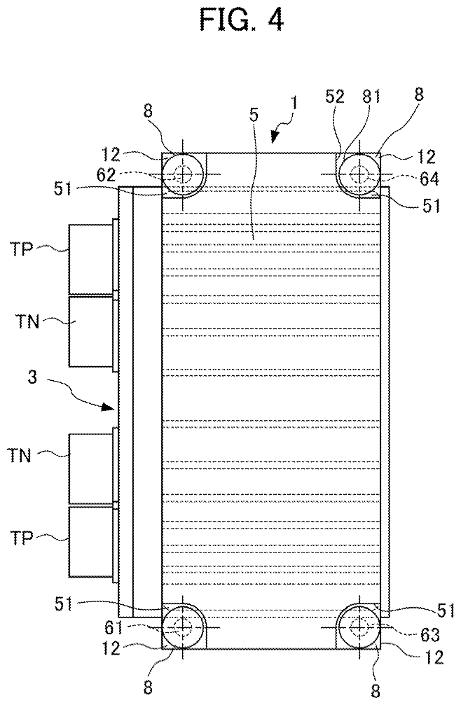

Next, a first embodiment of the present invention will be described with reference to the drawings. In the drawings shown below, the same components and corresponding components are denoted by the same reference numeral. FIG. 1 is a plan view of a battery module according to a first embodiment of the present invention, FIG. 2 is a side view of the battery module of FIG. 1, FIG. 3 illustrates the battery module of FIG. 1 as viewed from one end plate side, and FIG. 4 illustrates the battery module of FIG. 1 as viewed from the other end plate side.

A battery module 1 of the first embodiment is configured such that a stacked body 3 of a plurality of battery cells 2 in a flat shape that is a stacked body of laminate pack lithium-ion battery cells is pinched and held by a first end plate 4 and a second end plate 5 from both end sides in the stacking direction. Each battery cell 2 is configured such that a laminated electrodes LE are packed with a laminate sheet, and a positive terminal (positive tab) TP and a negative terminal (negative tab) TN are led out via a predetermined intra-cell connection. The battery cells 2 constitute the stacked body 3 in such a manner that a cell of one type in which a pair of terminals of a positive tab TP and a negative tab TN are arranged closer to the right end side and a cell of another type in which a pair of terminals thereof are arranged inversely and arranged closer to the left end side are alternately stacked. The first end plate 4 and the second end plate 5 are fastened in a direction of reducing the gap between the two end plates 4 and 5 with four connecting bolts 6 that are connecting members. Regarding the first end plate 4 and the second end plate 5, a facing surface that faces the stacked body 3 is denoted by a reference sign S1, and an opposite surface that is on the opposite side of the facing surface S1 is denoted by a reference sign S2.

The connecting bolt 6 includes a shaft portion 7 constituting the body, a head portion 8 formed on one end side of the shaft portion 7, and a male threaded portion 9 formed on the other end side of the shaft portion 7, and a nut 10 is screwed to the male threaded portion 9. On the other hand, the first end plate 4 has a pressure receiving portion 11 that is in surface contact with the nut 10 and receives the pressing force from the nut 10. Further, the second end plate 5 has a pressure receiving portion 12 that is in surface contact with the head portion 8 of the connecting bolt 6 and receives the pressing force from the nut 10. The pressure receiving portion 11 of the first end plate 4 and the pressure receiving portion 12 of the second end plate 5 are located at both end sides of one connecting bolt 6 and form a pair. Four pairs of the pressure receiving portion 11 and the pressure receiving portion 12 are provided corresponding to the four connecting bolts 6. That is, the four connecting bolts 6 connect a plurality of pairs (four pairs) of the pressure receiving portions 11 and 12 between the first end plate 4 and the second end plate 5.

In detail, as illustrated in FIGS. 1 to 4, the four connecting bolts 6 are a first connecting bolt 61, a second connecting bolt 62, a third connecting bolt 63, and a fourth connecting bolt 64. Here, when an attention is paid to the surroundings of the first connecting bolt 61, the pressing force from the nut 10 screwed to the male threaded portion 9 acts on the pressure receiving portion 11 of the first end plate 4. Note that in a fastened state, each nut 10 is housed in a recessed portion 41 formed in a thickness direction at each of the four corners of the opposite surface S2 on the opposite side of the facing surface S1 facing the stacked body 3 of the first end plate 4.

Further, the pressing force from the head portion 8 acts on the pressure receiving portion 12 of the second end plate 5. The first end plate 4 and the second end plate 5 each have four insertion holes 13 for allowing the four connecting bolts 6 to be inserted. In a portion of the connecting bolt 6 to be inserted into the insertion hole 13 in the vicinity of the position where the nut 10 is screwed to the male threaded portion 9, a nut-side large diameter portion 14 having a larger diameter than those of the male threaded portion 9 and the shaft portion 7 is formed coaxially. The nut-side large diameter portion 14 and the insertion hole 13 on the nut side partially constitute a detent mechanism part 15 (15a). The details of the detent mechanism part 15 will be described later.

Further, in a portion continuing to the head portion 8 of the connecting bolt 6 to be inserted into the insertion hole 13, a head-side large diameter portion 16 having a larger diameter than that of the shaft portion 7 is formed coaxially. The head-side large diameter portion 16 is closely fitted with a head-side spigot joint portion 17 particularly provided on the insertion hole 13, and the connecting bolt 6 is centered on the head portion 8 side.

On the other hand, the head portions 8 of the first connecting bolt 61, the second connecting bolt 62, the third connecting bolt 63, and the fourth connecting bolt 64 are in a substantially disk shape. The head portion 8 is housed in a recessed portion 51 formed in a thickness direction at each of the four corners of the opposite surface S2 on the opposite side of the facing surface S1 facing the stacked body 3 of the second end plate 5, whereby displacement around the shaft is not regulated. Therefore, each head portion 8 is free relative to the rotational displacement around the shaft, although there is rotational friction.

In the embodiment of the present invention illustrated in FIGS. 1 to 4, the first end plate 4 and the second end plate 5 each have a plurality of through holes H penetrating inside thereof in the surface inward direction. The longitudinal direction of each through hole H is a surface inward direction and an up and down direction of the first end plate 4 and the second end plate 5 (direction connecting the side where the electrode TP or TN is provided of each battery cell 2 and the opposite side). That is, the longitudinal direction of each through hole H is a direction vertically intersecting the sheet surface in FIG. 1, is an up and down direction in FIG. 2, and is a left and right direction in FIGS. 3 and 4.

As illustrated, among the plurality of through holes H, a through hole H00 at the center position in the up and down direction of the first end plate 4 and the second end plate 5 has the largest opening area. Through holes H11, . . . , H15, and H16 sequentially provided at positions rightward (lower side in FIG. 1) from the through hole H00 at the center position are formed to have opening areas that are gradually reduced sequentially. Further, through holes H21, . . . , H25, and H26 sequentially provided at positions leftward (upper side in FIG. 1) from the through hole H00 at the center position are formed to have opening areas that are gradually reduced sequentially.

The first end plate 4 and the second end plate 5 are provided with the through holes H00, H11, . . . , H15, H16, (H00), H21, . . . , H25, and H26 as described above. Therefore, in the first end plate 4, the section modulus between the two, left and right pressure receiving portions 11 and 11 is small at a portion where the through hole 100 is provided at the intermediate position between the two pressure receiving portions 11 and 11, and is large on the two pressure receiving portion sides (sides where the through hole H16 and the through hole H26 are provided). Similarly, in the second end plate 5, the section modulus between the two, left and right pressure receiving portions 12 and 12 is small at a portion where the through hole H00 is provided at the intermediate position between the two pressure receiving portions 12 and 12, and is large on the two pressure receiving portion 12 and 12 sides (sides where the through hole H16 and the through hole H26 are provided). The section modulus of each of the first end plate 4 and the second end plate 5 varies in stages in a discontinuous manner between the left and right two pressure receiving portions. With the structure in which changes in stages of the opening areas of the through holes are gradually changed at a plurality of stages, it is also possible to have an end plate having a form in which the section modulus varies in a pseudo continuous manner. Since the first end plate 4 and the second end plate 5 have a structure in which the section modulus varies in stages or in a pseudo continuous manner as described above, the surface pressure within the surface at the time of pinching and holding the stacked body 3 of the plurality of battery cells 2 takes a uniform value throughout the surface. Therefore, the surface pressure within the surface of each battery cell 2 constituting the stacked body 3 becomes uniform, and the battery module 1 can exhibits sufficient performance.

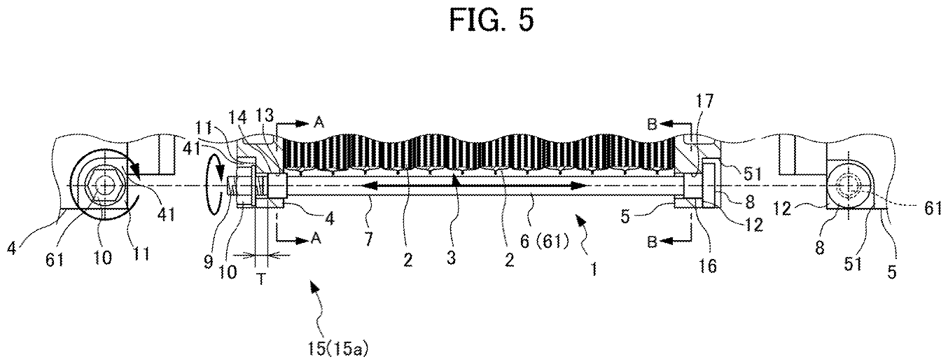

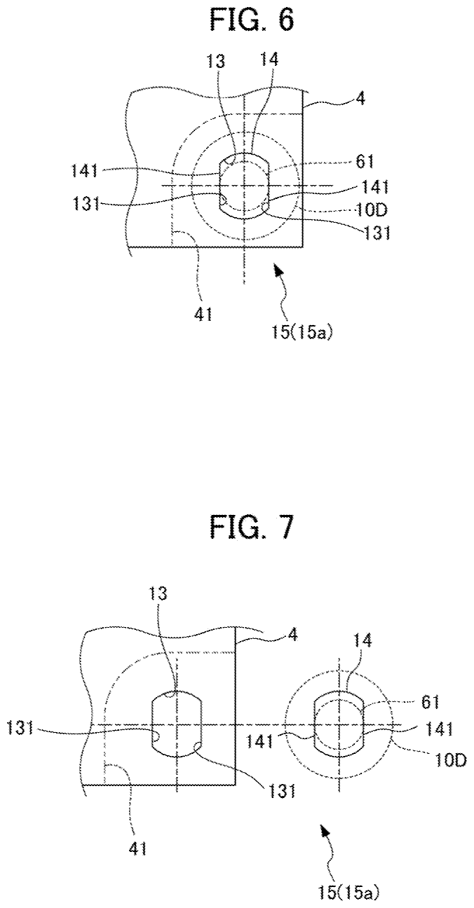

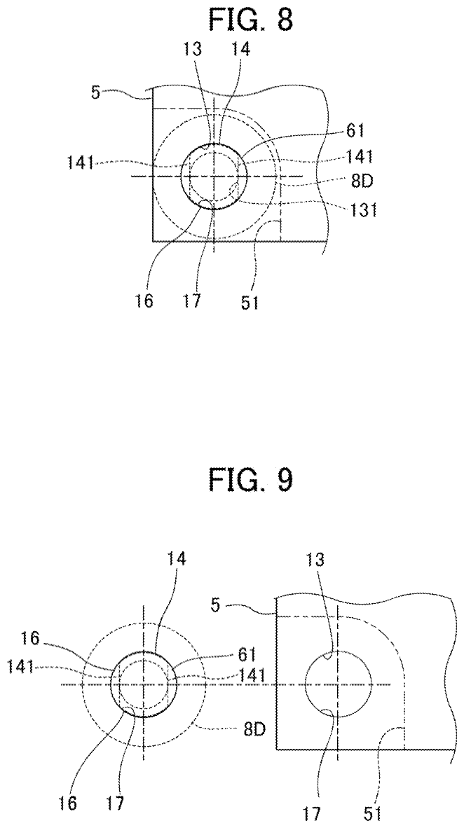

Next, the first embodiment of the present invention will be described in more detail with reference to FIGS. 5 to 9 as well. FIG. 5 illustrates a part surrounded by a circle C in FIG. 1 in an enlarged manner. On the left side in FIG. 5, a portion of the first end plate 4 as viewed from the nut 10 side is illustrated. On the right side in FIG. 5, a portion of the second end plate 5 as viewed from the head portion 8 side is illustrated. FIG. 6 is a cross-sectional view taken along line A-A in FIG. 5. FIG. 7 illustrates the elements in FIG. 6 separately. FIG. 8 is a cross-sectional view taken along line B-B in FIG. 5. FIG. 9 illustrates the elements in FIG. 8 separately.

In the first connecting bolt 61, the nut 10 is screwed to the male threaded portion 9 on the first end plate 4 side, and the head portion 8 formed on the second end plate 5 side. The pressing force from the nut 10 acts on the pressure receiving portion 11, and the pressing force from the head portion 8 acts on the pressure receiving portion 12. In a portion of the connecting bolt 61 to be inserted into the insertion hole 13 in the vicinity of the position where the nut 10 is screwed to the male threaded portion 9, a nut-side large diameter portion 14 having a larger diameter than those of the male threaded portion 9 and the shaft portion 7 is formed coaxially. The nut-side large diameter portion 14 and the insertion hole 13 on the nut side partially constitute the detent mechanism part 15 (15a) as illustrated in FIGS. 6 and 7. On the other hand, the head portion 8 of the first connecting bolt 61 is housed in the recessed portion 51 formed in the second end plate 5. While displacement around the shaft is not regulated, rotational operation will never be performed from the outside. The head portion 8 functions exclusively to receive the shaft force of the first connecting bolt 61.

Referring to FIGS. 6 and 7, the detent mechanism part 15 (15a) will be described in detail. The detent mechanism part 15 (15a) is configured of a pair of cutout portions 141 formed parallel to the nut-side large diameter portion 14 of the first connecting bolt 61 over the shaft, and a pair of flat portions 131 formed on the insertion hole 13 corresponding to the pair of cutout portions 141. In this case, both the pair of cutout portions 141 and the pair of flat portions 131 are housed in a seat diameter 10D of the nut 10 located in the recessed portion 41 of the first end plate 4. The pair of cutout portions 141 fit between the pair of flat portions 131 without any gap and contact, whereby the rotational displacement around the shaft of the first connecting bolt 61 is regulated.

Next, a configuration around the head portion 8 provided on the second end plate 5 side of the first connecting bolt 61 will be described in detail with reference to FIGS. 8 and 9. Regarding the head portion 8 in a substantially disk shape, the entire seat diameter 8D of the head portion 8 is housed in the recessed portion 51 on the second end plate 5 side. Therefore, on the head portion 8 side of the first connecting bolt 61, the rotational displacement around the shaft is not regulated, so that the rotational displacement is allowed although friction with the pressure receiving portion 12 described above is generated. Note that in FIGS. 8 and 9, respective portions constituting the detent mechanism part 15 (15a) described with reference to FIGS. 6 and 7 are illustrated with broken lines with reference numerals.

Here, the head-side large diameter portion 16 formed coaxially on the connecting bolt 6 is closely fitted with the head-side spigot joint portion 17 particularly provided in the insertion hole 13, and the connecting bolt 6 is centered on the head portion 6 side. Therefore, the axial center position of the connecting bolt 6 is held at a normal position.

Description will be given on FIG. 5 again. By rotating the nut 10 of the first connecting bolt 61 in an arcuate arrow direction to fasten it, axial force is caused to act on the shaft portion 7 of the first connecting bolt 61 as illustrated in a double-headed arrow in the axial direction. Thereby, the stacked body 3 of the battery cells 2 is pinched and held by the first end plate 4 and the second end plate 5 from both end sides in the stacking direction. The detent mechanism part 15 (15a) described above is provided in the vicinity of the fastening portion of the nut 10 on the male threaded portion 9 of the connecting bolt 61. Here, vicinity means a degree in which a distance T in the axial direction from the position where the seat of the nut 10 is in contact with the pressure receiving portion 11 of the first end plate 4 to the nut 10 side end of the detent mechanism part 15 (15a) is shorter than the thickness dimension of the first end plate 4 (in particular, in the case of the example illustrated in FIG. 5, the thickness dimension in the recessed portion 41 of the first end plate 4). Therefore, the residual torsion (torsion stress) around the shaft caused by fastening of the nut 10 is generated limitedly within the range of the distance T described above in the first connecting bolt 61. On the other hand, a major section of the entire length of the first connecting bolt 61, from the detent mechanism part 15 (15a) to the second end plate 5, is not affected by the displacement around the shaft from the head portion 8 on the second end plate 5 side. Accordingly, the major section of the entire length of the first connecting bolt 61 has no residual torsion. As a result, it is possible to prevent looseness of the nut 10 of the first connecting bolt 61 during use of the battery module 1 for a long period. Therefore, it is possible to reduce a strict management work for a friction coefficient between the nut 10 and the pressure receiving portion 11. Further, since only the axial force indicated by the double-headed arrow acts exclusively on the major section of the entire length of the first connecting bolt 61, the effective strength of the shaft portion 7 is enhanced.

Regarding the first embodiment, the configuration and the action and effect around the first connecting bolt 61 have been described in detail representatively with reference to FIGS. 5 to 9. The points described above regarding the surroundings of the first connecting bolt 61 in the first embodiment are the same in the four connecting bolts 6, namely the first connecting bolt 61, the second connecting bolt 62, the third connecting bolt 63, and the fourth connecting bolt 64.

### Second Embodiment

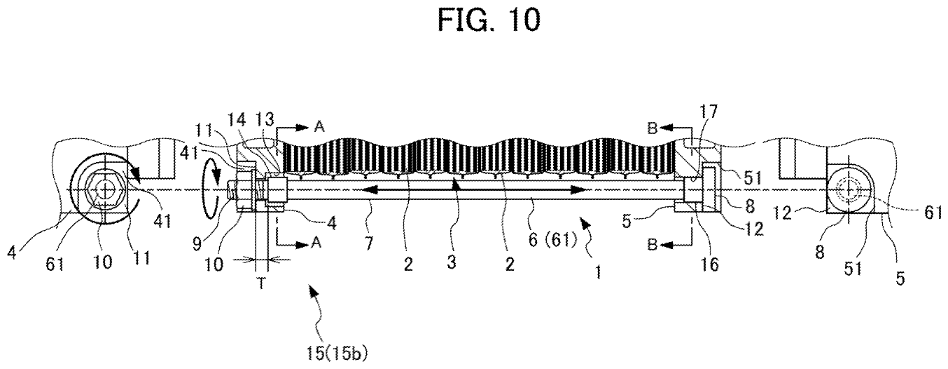

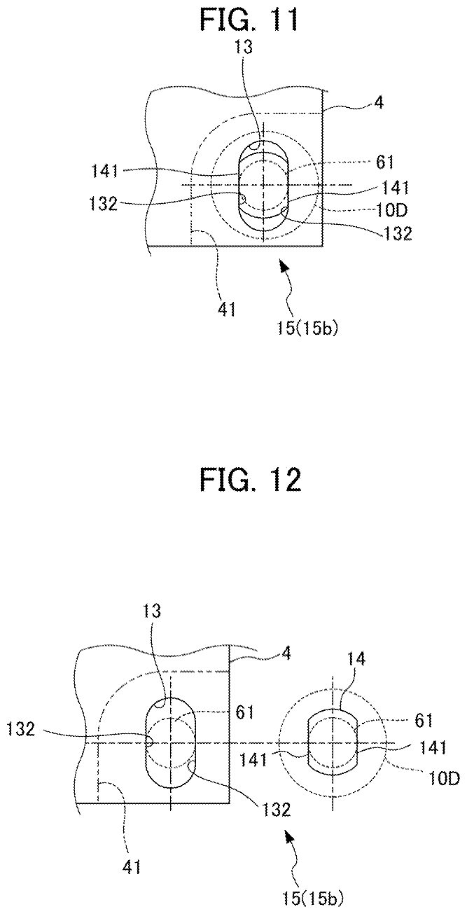

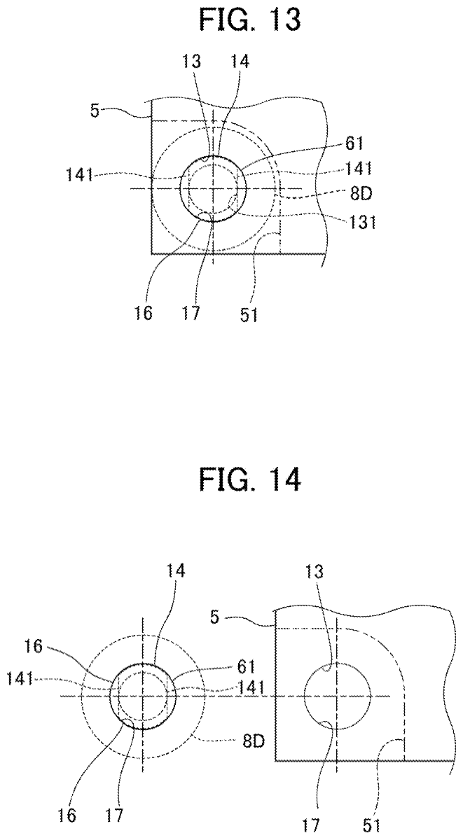

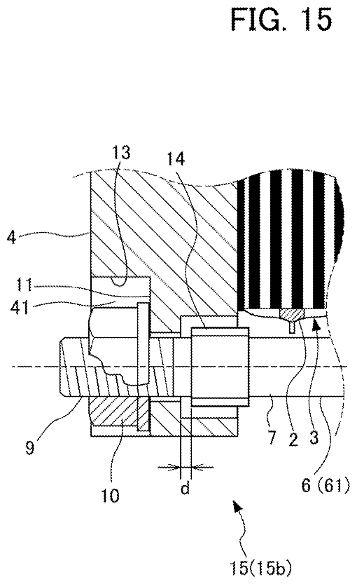

Next, a second embodiment of the present invention will be described with reference to FIGS. 10 to 15. FIG. 10 illustrates a portion corresponding to the portion encircled with the circle C in FIG. 1 described above in an enlarged manner, in the second embodiment of the present invention. On the left side in FIG. 10, a portion of the first end plate 4 as viewed from the nut 10 side is illustrated. On the right side in FIG. 10, a portion of the second end plate 5 as viewed from the head portion 8 side is illustrated. FIG. 11 is a cross-sectional view taken along line A-A in FIG. 10. FIG. 12 illustrates the elements in FIG. 11 separately. FIG. 13 is a cross-sectional view taken along line B-B in FIG. 10. FIG. 14 illustrates the elements in FIG. 13 separately. FIG. 15 illustrates surroundings of a detent mechanism in FIG. 10 in an enlarged manner.

In the first connecting bolt 61, the nut 10 is screwed to the male threaded portion 9 on the first end plate 4 side, and the head portion 8 is formed on the second end plate 5 side. The pressing force from the nut 10 acts on the pressure receiving portion 11, and the pressing force from the head portion 8 acts on the pressure receiving portion 12. In a portion of the connecting bolt 61 to be inserted into the insertion hole 13 in the vicinity of the position where the nut 10 is screwed to the male threaded portion 9, a nut-side large diameter portion 14 having a larger diameter than those of the male threaded portion 9 and the shaft portion 7 is formed coaxially. The nut-side large diameter portion 14 and the insertion hole 13 on the nut side partially constitute the detent mechanism part 15 (15a) as illustrated in FIGS. 11 and 12. On the other hand, the head portion 8 of the first connecting bolt 61 is housed in the recessed portion 51 formed in the second end plate 5. While displacement around the shaft is not regulated, rotational operation will never be performed from the outside. The head portion 8 functions exclusively to receive the shaft force of the first connecting bolt 61.

Referring to FIGS. 11, 12, and 15, the detent mechanism part 15 (15b) will be described in detail. The detent mechanism part 15 (15b) is configured of a pair of cutout portions 141 formed parallel to the nut-side large diameter portion 14 of the first connecting bolt 61 over the shaft, and a pair of flat portions 131 formed on the insertion hole 13 corresponding to the pair of cutout portions 141. In this case, both the pair of cutout portions 141 and the pair of flat portions 131 are housed in a seat diameter 10D of the nut 10 located in the recessed portion 41 of the first end plate 4. The pair of cutout portions 141 in the nut-side large diameter portion 14 of the first connecting bolt 61 fit between the pair of flat portions 131 on the insertion hole 13 and contact, whereby the rotational displacement around the shaft of the first connecting bolt 61 is regulated. In the present embodiment, as is clear also with reference to FIG. 15 illustrating the detent mechanism part 15 (15b) in an enlarged manner, the radial dimension of a portion other than the pair of flat portions 131 in the insertion hole 13 is larger than the gap between the pair of flat portions 131. Further, it is configured such that in the diameter of the insertion hole 13, a clearance d is provided between an end surface of a portion where a step is formed from the portion for accommodating the nut-side large diameter portion 14 of the first connecting bolt 61 to a portion into which the male threaded portion 9 is inserted and the diameter is decreased, and an end surface of the nut-side large diameter portion 14 facing such an end surface. Therefore, it is possible to flexibly adapt to the dimensional tolerance around the detent mechanism part 15 (15b) and expansion or contraction of the member caused by a temperature change.

Next, a configuration around the head portion 8 provided on the second end plate 5 side of the first connecting bolt 61 will be described in detail with reference to FIGS. 13 and 14. Regarding the head portion 8 in a substantially disk shape, the entire seat diameter 8D of the head portion 8 is housed in the recessed portion 51 on the second end plate 5 side. Therefore, on the head portion 8 side of the first connecting bolt 61, the rotational displacement around the shaft is not regulated, so that the rotational displacement is allowed although friction with the pressure receiving portion 12 described above is generated. Note that in FIGS. 13 and 14, respective portions constituting the detent mechanism part 15 (15b) described with reference to FIGS. 11 and 12 are illustrated using broken lines with reference numerals.

Here, the head-side large diameter portion 16 formed coaxially on the connecting bolt 6 is closely fitted with the head-side spigot joint portion 17 particularly provided in the insertion hole 13, and the connecting bolt 6 is centered on the head portion 8 side. Therefore, the axial center position of the connecting bolt 6 is held at a normal position.

Description will be given on FIG. 10 again. By rotating the nut 10 of the first connecting bolt 61 in an arcuate arrow direction to fasten it, axial force is caused to act on the shaft portion 7 of the first connecting bolt 61 as illustrated in a double-headed arrow in the axial direction. Thereby, the stacked body 3 of the battery cells 2 is pinched and held by the first end plate 4 and the second end plate 5 from both end sides in the stacking direction. The detent mechanism part 15 (15b) described above is provided in the vicinity of the fastening portion of the nut 10 on the male threaded portion 9 of the connecting bolt 61. Here, vicinity means a degree in which the distance T in the axial direction from the position where the seat of the nut 10 is in contact with the pressure receiving portion 21 of the first end plate 4 to the nut 10 side end of the detent mechanism part 15 (15b) is shorter than the thickness dimension of the first end plate 4 (in particular, in the case of the example illustrated in FIG. 10, the thickness dimension in the recessed portion 41 of the first end plate 4). Therefore, the residual torsion (torsion stress) around the shaft caused by fastening of the nut 10 is generated limitedly within the range of the distance T described above in the first connecting bolt 61. On the other hand, a major section of the entire length of the first connecting bolt 61, from the detent mechanism part 15 (15b) to the second end plate 5, is not affected by the displacement around the shaft from the head portion 8 on the second end plate 5 side. Accordingly, the major section of the entire length of the first connecting bolt 61 has no residual torsion. As a result, it is possible to prevent looseness of the nut 10 of the first connecting bolt 61 during use of the battery module 1 for a long period. Therefore, it is possible to reduce a strict management work for a friction coefficient between the nut 10 and the pressure receiving portion 11. Further, since only the axial force indicated by the double-headed arrow acts exclusively on the major section of the entire length of the first connecting bolt 61, the effective strength of the shaft portion 7 is enhanced.

Regarding the second embodiment, the configuration and the action and effect around the first connecting bolt 61 have been described in detail representatively, with reference to FIGS. 10 to 15. The points described above regarding the surroundings of the first connecting bolt 61 in the second embodiment are the same in the four connecting bolts 6, namely the first connecting bolt 61, the second connecting bolt 62, the third connecting bolt 63, and the fourth connecting bolt 64.

### Third Embodiment

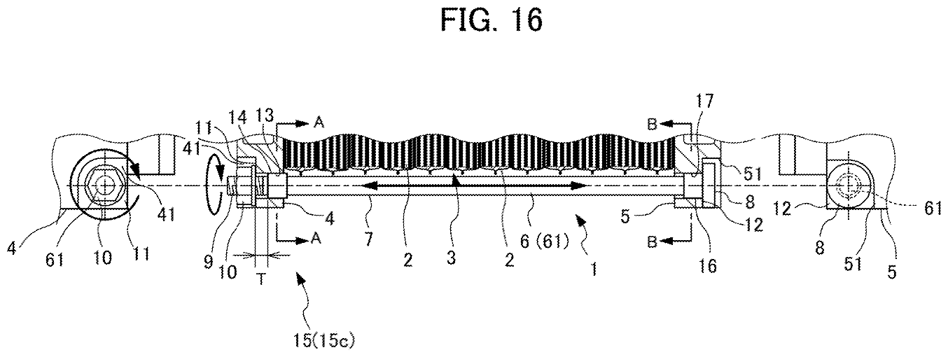

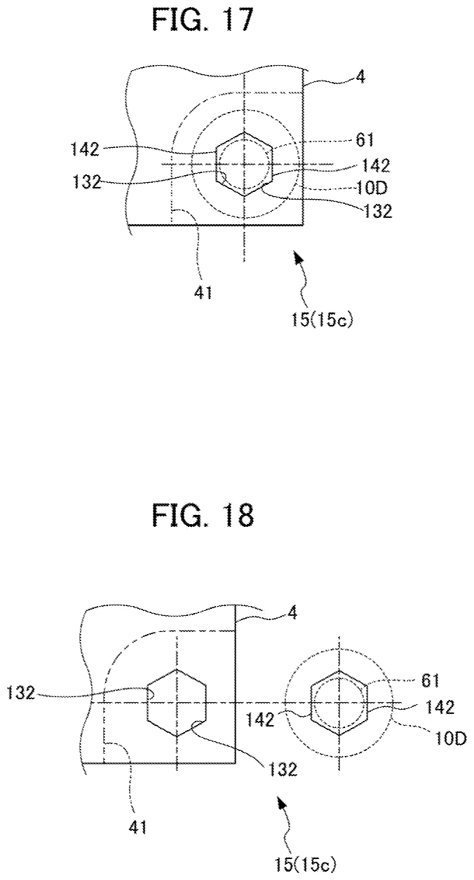

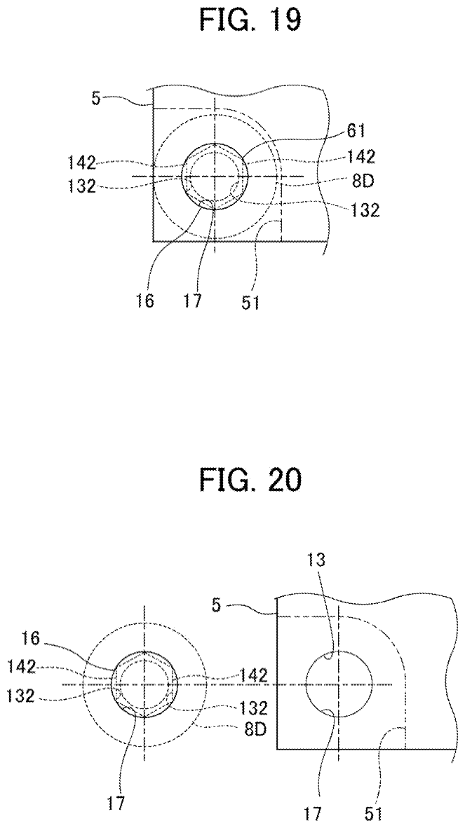

Next, a third embodiment of the present invention will be described with reference to FIGS. 16 to 20. FIG. 16 illustrates a portion corresponding to the portion encircled with the circle C in FIG. 1 described above in an enlarged manner, in the third embodiment of the present invention. On the left side in FIG. 16, a portion of the first end plate 4 as viewed from the nut 10 side is illustrated. On the right side in FIG. 16, a portion of the second end plate 5 as viewed from the head portion 8 side is illustrated. FIG. 17 is a cross-sectional view taken along line A-A in FIG. 16. FIG. 18 illustrates the elements in FIG. 17 separately. FIG. 19 is a cross-sectional view taken along line B-B in FIG. 16. FIG. 20 illustrates the elements in FIG. 19 separately.

In the first connecting bolt 61, the nut 10 is screwed to the male threaded portion 9 on the first end plate 4 side, and the head portion 8 is formed on the second end plate 5 side. The pressing force from the nut 10 acts on the pressure receiving portion 11, and the pressing force from the head portion 8 acts on the pressure receiving portion 12. In a portion of the connecting bolt 61 to be inserted into the insertion hole 13 in the vicinity of the position where the nut 10 is screwed to the male threaded portion 9, a nut-side large diameter portion 14 having a larger diameter than those of the male threaded portion 9 and the shaft portion 7 is formed coaxially. The nut-side large diameter portion 14 and the insertion hole 13 on the nut side partially constitute the detent mechanism part 15 (15c) as illustrated in FIGS. 17 and 18. On the other hand, the head portion 8 of the first connecting bolt 61 is housed in the recessed portion 51 formed in the second end plate 5. While displacement around the shaft is not regulated, rotational operation will never be performed from the outside. The head portion 8 functions exclusively to receive the shaft force of the first connecting bolt 61.

Referring to FIGS. 17 and 18, the detent mechanism part 15 (15b) will be described in detail. The detent mechanism part 15 (15c) is configured of an angular shaft portion 142 in a regular hexagonal shape as viewed from the axial direction formed on the nut-side large diameter portion 14 of the first connecting bolt 61, and an angular hole portion 132 in a regular hexagonal shape as viewed from the axial direction formed on the insertion hole 13 corresponding to the angular shaft portion 142. In this case, both the angular shaft portion 142 and the angular hole portion 132 are housed in the seat diameter 10D of the nut 10 located in the recessed portion 41 of the first end plate 4. The angular shaft portion 142 in the nut-side large diameter portion 14 of the first connecting bolt 61 fit closely in the angular hole portion 132 on the insertion hole 13 and the surfaces corresponding to each other thereof substantially contact each other, whereby the rotational displacement around the shaft of the first connecting bolt 61 is regulated.

Next, a configuration around the head portion 8 provided on the second end plate 5 side of the first connecting bolt 61 will be described in detail with reference to FIGS. 19 and 20. Regarding the head portion 8 in a substantially disk shape, the entire seat diameter 8D of the head portion 8 is housed in the recessed portion 51 on the second end plate 5 side.

Therefore, on the head portion 8 side of the first connecting bolt 61, the rotational displacement around the shaft is not regulated, so that the rotational displacement is allowed although friction with the pressure receiving portion 12 described above is generated. Note that in FIGS. 19 and 20, respective portions constituting the detent mechanism part 15 (15c) described with reference to FIGS. 17 and 18 are illustrated using broken lines with reference numerals.

Here, the head-side large diameter portion 16 formed coaxially on the connecting bolt 6 is closely fitted with the head-side spigot joint portion 17 particularly provided in the insertion hole 13, and the connecting bolt 6 is centered on the head portion 8 side. Therefore, the axial center position of the connecting bolt 6 is held at a normal position.

Description will be given on FIG. 16 again. By rotating the nut 10 of the first connecting bolt 61 in an arcuate arrow direction to fasten it, axial force is caused to act on the shaft portion 7 of the first connecting bolt 61 as illustrated in a double-headed arrow in the axial direction. Thereby, the stacked body 3 of the battery cells 2 is pinched and held by the first end plate 4 and the second end plate 5 from both end sides in the stacking direction. The detent mechanism part 15 (15c) described above is provided in the vicinity of the fastening portion of the nut 10 on the male threaded portion 9 of the connecting bolt 61. Here, vicinity means a degree in which the distance T in the axial direction from the position where the seat of the nut 10 is in contact with the pressure receiving portion 21 of the first end plate 4 to the nut 10 side end of the detent mechanism part 15 (15c) is shorter than the thickness dimension of the first end plate 4 (in particular, in the case of the example illustrated in FIG. 16, the thickness dimension in the recessed portion 41 of the first end plate 4). Therefore, the residual torsion (torsion stress) around the shaft caused by fastening of the nut 10 is generated limitedly within the range of the distance T described above in the first connecting bolt 61. On the other hand, a major section of the entire length of the first connecting bolt 61, from the detent mechanism part 15 (15c) to the second end plate 5, is not affected by the displacement around the shaft from the head portion 8 on the second end plate 5 side. Accordingly, the major section of the entire length of the first connecting bolt 61 has no residual torsion. As a result, it is possible to prevent looseness of the nut 10 of the first connecting bolt 61 during use of the battery module 1 for a long period. Therefore, it is possible to reduce a strict management work for a friction coefficient between the nut 10 and the pressure receiving portion 11. Further, since only the axial force indicated by the double-headed arrow acts exclusively on the major section of the entire length of the first connecting bolt 61, the effective strength of the shaft portion 7 is enhanced.

Regarding the third embodiment, the configuration and the action and effect around the first connecting bolt 61 have been described in detail representatively, with reference to FIGS. 16 to 20. The points described above regarding the surroundings of the first connecting bolt 61 in the third embodiment are the same in the four connecting bolts 6, namely the first connecting bolt 61, the second connecting bolt 62, the third connecting bolt 63, and the fourth connecting bolt 64.

### Fourth Embodiment

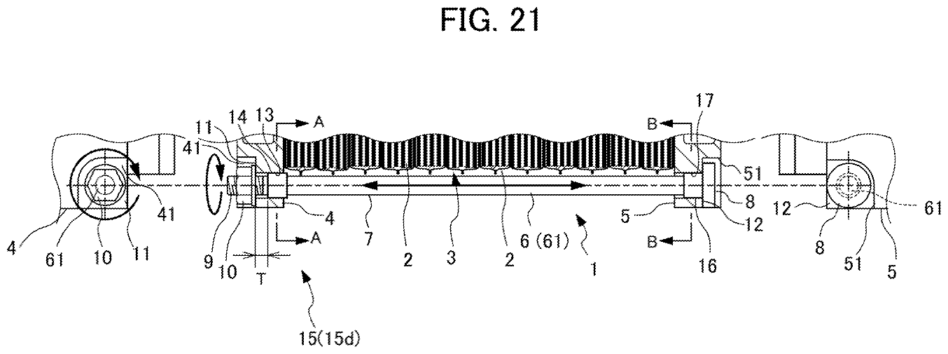

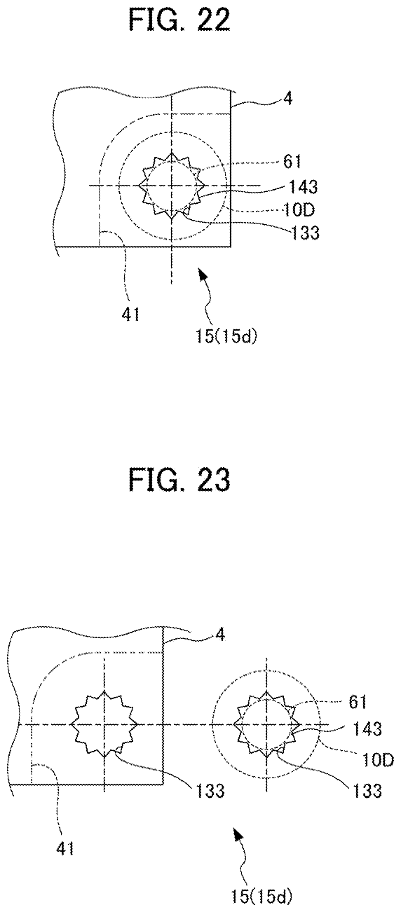

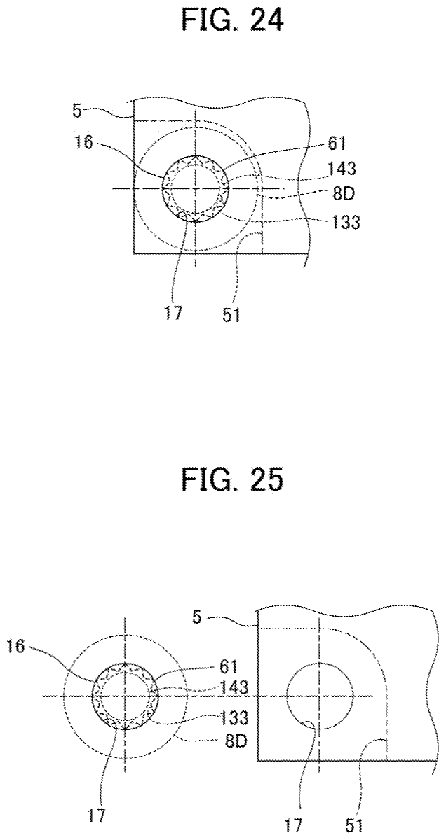

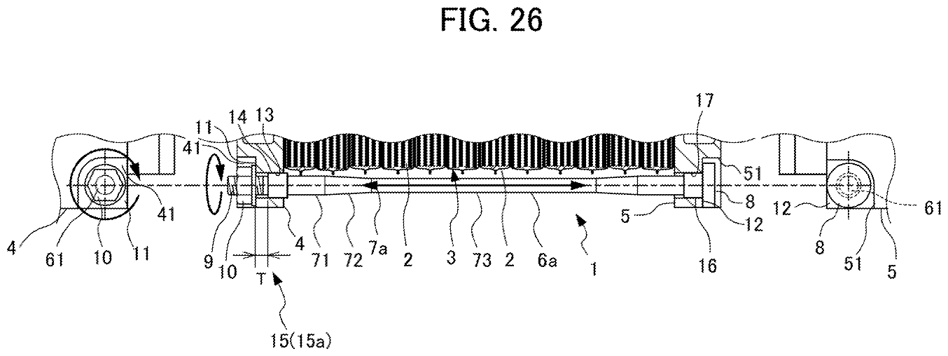

Next, a fourth embodiment of the present invention will be described with reference to FIGS. 21 to 25. FIG. 21 illustrates a portion corresponding to the portion encircled with the circle C in FIG. 1 described above in an enlarged manner, in the fourth embodiment of the present invention. On the left side in FIG. 21, a portion of the first end plate 4 as viewed from the nut 10 side is illustrated. On the right side in FIG. 21, a portion of the second end plate 5 as viewed from the head portion 8 side is illustrated. FIG. 22 is a cross-sectional view taken along line A-A in FIG. 21. FIG. 23 illustrates the elements in FIG. 22 separately. FIG. 24 is a cross-sectional view taken along line B-B in FIG. 21. FIG. 25 illustrates the elements in FIG. 24 separately.

In the first connecting bolt 61, the nut 10 is screwed to the male threaded portion 9 on the first end plate 4 side, and the head portion 8 is formed on the second end plate 5 side.

The pressing force from the nut 10 acts on the pressure receiving portion 11, and the pressing force from the head portion 8 acts on the pressure receiving portion 12. In a portion of the connecting bolt 61 to be inserted into the insertion hole 13 in the vicinity of the position where the nut 10 is screwed to the male threaded portion 9, a nut-side large diameter portion 14 having a larger diameter than those of the male threaded portion 9 and the shaft portion 7 is formed coaxially. The nut-side large diameter portion 14 and the insertion hole 13 on the nut side partially constitute the detent mechanism part 15 (15d) as illustrated in FIGS. 22 and 23. On the other hand, the head portion 8 of the first connecting bolt 61 is housed in the recessed portion 51 formed in the second end plate 5. While displacement around the shaft is not regulated, rotational operation will never be performed from the outside. The head portion 8 functions exclusively to receive the shaft force of the first connecting bolt 61.

Referring to FIGS. 22 and 23, the detent mechanism part 15 (15d) will be described in detail. The detent mechanism part 15 (15d) is configured of a serrated shaft portion 143 in a serration shape as viewed from the axial direction formed on the nut-side large diameter portion 14 of the first connecting bolt 61, and a serrated hole portion 133 in a serration shape as viewed from the axial direction formed on the insertion hole 13 corresponding to the serrated shaft portion 143. In this case, both the serrated shaft portion 143 and the serrated hole portion 133 are housed in the seat diameter 10D of the nut 10 located in the recessed portion 41 of the first end plate 4. The serrated shaft portion 143 in the nut-side large diameter portion 14 of the first connecting bolt 61 fit closely in the serrated hole portion 133 on the insertion hole 13 and the surfaces corresponding to each other thereof substantially contact each other, whereby the rotational displacement around the shaft of the first connecting bolt 61 is regulated.

Next, a configuration around the head portion 8 provided on the second end plate 5 side of the first connecting bolt 61 will be described in detail with reference to FIGS. 24 and 25. Regarding the head portion 8 in a substantially disk shape, the entire seat diameter 8D of the head portion 8 is housed in the recessed portion 51 on the second end plate 5 side. Therefore, on the head portion 8 side of the first connecting bolt 61, the rotational displacement around the shaft is not regulated, so that the rotational displacement is allowed although friction with the pressure receiving portion 12 described above is generated. Note that in FIGS. 24 and 25, respective portions constituting the detent mechanism part 15 (15d) described with reference to FIGS. 22 and 23 are illustrated using broken lines with reference numerals.

Here, the head-side large diameter portion 16 formed coaxially on the connecting bolt 6 is closely fitted with the head-side spigot joint portion 17 particularly provided in the insertion hole 13, and the connecting bolt 6 is centered on the head portion 8 side. Therefore, the axial center position of the connecting bolt 6 is held at a normal position.

Description will be given on FIG. 21 again. By rotating the nut 10 of the first connecting bolt 61 in an arcuate arrow direction to fasten it, axial force is caused to act on the shaft portion 7 of the first connecting bolt 61 as illustrated in a double-headed arrow in the axial direction. Thereby, the stacked body 3 of the battery cells 2 is pinched and held by the first end plate 4 and the second end plate 5 from both end sides in the stacking direction. The detent mechanism part 15 (15d) described above is provided in the vicinity of the fastening portion of the nut 10 on the male threaded portion 9 of the connecting bolt 61. Here, vicinity means a degree in which a distance T in the axial direction from the position where the seat of the nut 10 is in contact with the pressure receiving portion 11 of the first end plate 4 to the nut 10 side end of the detent mechanism part 15 (15d) is shorter than the thickness dimension of the first end plate 4 (in particular, in the case of the example illustrated in FIG. 21, the thickness dimension in the recessed portion 41 of the first end plate 4). Therefore, the residual torsion (torsion stress) around the shaft caused by fastening of the nut 10 is generated limitedly within the range of the distance T described above in the first connecting bolt 61. On the other hand, a major section of the entire length of the first connecting bolt 61, from the detent mechanism part 15 (15d) to the second end plate 5, is not affected by the displacement around the shaft from the head portion 8 on the second end plate 5 side. Accordingly, the major section of the entire length of the first connecting bolt 61 has no residual torsion. As a result, it is possible to prevent looseness of the nut 10 of the first connecting bolt 61 during use of the battery module 1 for a long period. Therefore, it is possible to reduce a strict management work for a friction coefficient between the nut 10 and the pressure receiving portion 11. Further, since only the axial force indicated by the double-headed arrow acts exclusively on the major section of the entire length of the first connecting bolt 61, the effective strength of the shaft portion 7 is enhanced.

Regarding the fourth embodiment, the configuration and the action and effect around the first connecting bolt 61 have been described in detail representatively, with reference to FIGS. 21 to 25. The points described above regarding the surroundings of the first connecting bolt 61 in the fourth embodiment are the same in the four connecting bolts 6, namely the first connecting bolt 61, the second connecting bolt 62, the third connecting bolt 63, and the fourth connecting bolt 64.

### Fifth Embodiment

Next, a fifth embodiment of the present invention will be described with reference to FIG. 26. FIG. 26 illustrates a portion corresponding to the portion encircled with the circle C in FIG. 1 described above in an enlarged manner, in the fifth embodiment of the present invention. On the left side in FIG. 26, a portion of the first end plate 4 as viewed from the nut 10 side is illustrated. On the right side in FIG. 26, a portion of the second end plate 5 as viewed from the head portion 8 side is illustrated.

In the first connecting bolt 61, the nut 10 is screwed to the male threaded portion 9 on the first end plate 4 side, and the head portion 8 is formed on the second end plate 5 side. The pressing force from the nut 10 acts on the pressure receiving portion 11, and the pressing force from the head portion 8 acts on the pressure receiving portion 12. In a portion of the connecting bolt 61 to be inserted into the insertion hole 13 in the vicinity of the position where the nut 10 is screwed to the male threaded portion 9, a nut-side large diameter portion 14 having a larger diameter than those of the male threaded portion 9 and the shaft portion 7 is formed coaxially. The nut-side large diameter portion 14 and the insertion hole 13 on the nut side partially constitute the detent mechanism part 15 that is similar to that described with reference to FIGS. 6 and 7. On the other hand, the head portion 8 of the first connecting bolt 61 is housed in the recessed portion 51 formed in the second end plate 5. While displacement around the shaft is not regulated, rotational operation will never be performed from the outside. The head portion 8 functions exclusively to receive the shaft force of the first connecting bolt 61.

In the fifth embodiment, the diameter of the first connecting bolt 61 is not constant in the axial direction. That is, while certain sections on both end sides are both end side normal diameter portions 71 and 71 each having a diameter similar to that of the connecting bolt 6 of the first to fourth embodiments, an intermediate section between both ends has a diameter that is smaller than those of both the end side normal diameter portions 71 and 71. In detail, the diameter dimension is changed corresponding to the position in the axial direction from both the end side normal diameter portions 71 and 71 via tapered portions 72 and 72 in each of which the diameter dimension is gradually decreased, to an intermediate small-diameter portion 73 having the smallest diameter. This is because since the detent mechanism part 15 is provided at a position in the vicinity of the nut 10, the sections in the tapered portions 72 and 72 and the intermediate small-diameter portion 73 have no residual torsion so that no stress other than the shaft is applied, it is possible to withstand the axial force sufficiently with the small diameter. Further, because of a small diameter, the weight of the first connecting bolt 61 that is a rod-shaped connecting member is reduced.

Here, the head-side large diameter portion 16 formed coaxially with the connecting bolt 6 is closely fitted with the head-side spigot joint portion 17 particularly provided as an insertion hole, and the connecting bolt 6 is centered on the head portion 8 side. Therefore, the axial center position of the connecting bolt 6 is held at a normal position.

Regarding the fifth embodiment, the configuration and the action and effect around the first connecting bolt 61 have been described in detail representatively, with reference to FIG. 26. The points described above regarding the surroundings of the first connecting bolt 61 in the fifth embodiment are the same in the four connecting bolts 6, namely the first connecting bolt 61, the second connecting bolt 62, the third connecting bolt 63, and the fourth connecting bolt 64.

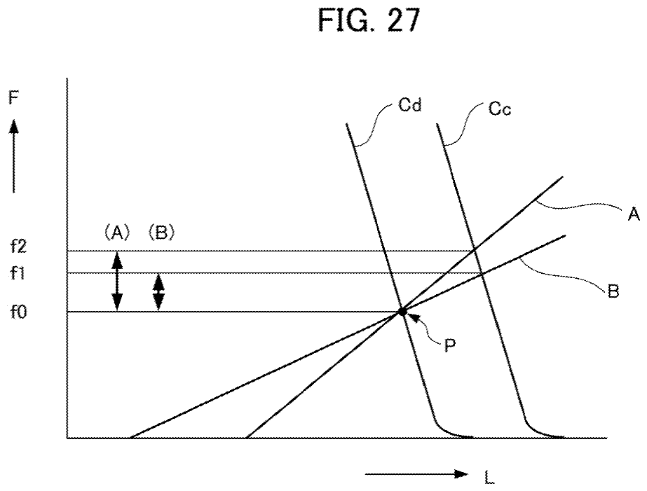

FIG. 27 is a diagram for explaining dynamic characteristics of the present invention in comparison with a conventional example. In FIG. 27, the horizontal axis shows a stacking length L of the stacked body 3 of the battery cells 2, and the vertical axis shows a binding load F on the stacked body 3 by the end plates 4 and 5.

“A” represents change characteristics of the binding load in a conventional example, “B” represents change characteristics of the binding load in the present invention, “Cc” represents change characteristics of the binding load required for the stacked body 3 in a high-charged state, and “Cd” represents change characteristics of the binding load required for the stacked body 3 in a low-charged state.

In FIG. 27, when the stacked body 3 is in a low-charged state, the size (stacking length L) is smaller than that in the high-charged state. However, in any low-charged state, a binding load f0 corresponding to a point P is required as a minimum required binding load. As the stacked body 3 shifts to a high-charged state, the stacking length L is increased and the required binding load is increased. The change amount of the binding load during the increase is from f0 to f2 in the conventional example (A). On the other hand, in the present invention (B), the change amount of the binding load is only from f0 to f1. This means that in the present invention (B), the necessary strength of related structural members such as connecting bolts and end plates can be kept low. Further, since the change width of the load applied to the end plates and the like is small, the change amount of the set deformed shape caused by the load is small. Therefore, variations in the surface pressure by the end plates can be kept small.

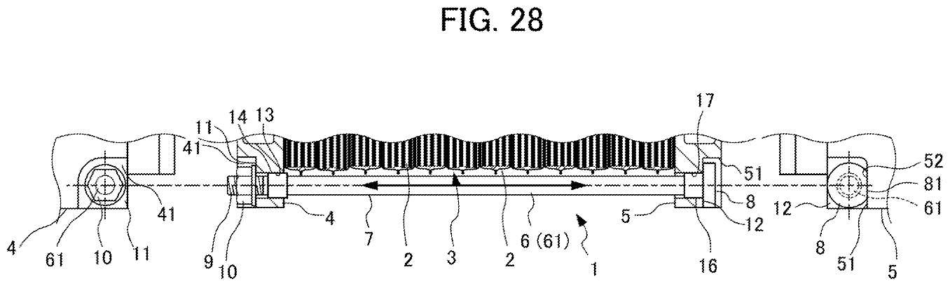

FIG. 28 illustrates a configuration of the conventional example compared in FIG. 27. FIG. 27 illustrates a portion in the conventional example, corresponding to the portion encircled with the circle C in FIG. 1 described above, in an enlarged manner. On the left side in FIG. 28, a portion of the first end plate 4 as viewed from the nut 10 side is illustrated. On the right side in FIG. 28, a portion of the second end plate 5 as viewed from the head portion 8 side is illustrated.

In the first connecting bolt 61, the nut 10 is screwed to the male threaded portion 9 on the first end plate side, and the head portion 8 formed on the second end plate 5 side. The pressing force from the nut 10 acts on the pressure receiving portion 11, and the pressing force from the head portion 8 acts on the pressure receiving portion 12. In the vicinity of the position where the nut 10 is screwed to the male threaded portion 9 of the connecting bolt 61, a detent mechanism part as in the present invention is not provided. On the other hand, the head portion 8 of the first connecting bolt 61 has a cutout portion 81 for preventing rotation. On the recessed portion 51 of the second end plate 5, a contact surface 52 for preventing rotation is formed corresponding to the cutout portion. The cutout portion 81 contacts the contact surface 52 whereby the first connecting bolt 61 is prevented from rotating on the head portion 8 side. Therefore, in the conventional example, the residual torsion remains in almost entire length of the first connecting bolt 61. This is almost the same in the four connecting bolts 6 of the conventional example.

According to the battery module of the present embodiment, the advantageous effects described below are exhibited.

In the battery module 1 of (1), the four connecting bolts 6 each have a fastening portion in which the nut 10 is screwed to the male threaded portion 9 on the first end plate 4 side of the first end plate 4 and the second end plate 5, and also have the detent mechanism part 15 in the vicinity of the fastening portion (separation distance T from the nut 10). Therefore, at the time of fastening operation, the residual torsion (torsion stress) in the fastening portion is generated limitedly in a section corresponding to the vicinity described above. On the other hand, a major section of the entire length of each of the four connecting bolts 61, from the detent mechanism part 15 to the second end plate 5 side, is not affected by the displacement around the shaft from the second end plate 5 side. Accordingly, the major section of the entire length of each of the four connecting bolts 61 has no residual torsion. As a result, it is possible to prevent looseness of the fastening portion of each of the four connecting bolts 61 during use of the battery module 1.

In the battery module 1 of (2), the second end plate 5, of the first end plate 4 and the second end plate 5, which is away from the fastening portion including the nut 10 screwed to the male threaded portion 9 of each of the four connecting bolts 6, has the head-side spigot joint portion 17 that is coaxial with the detent mechanism part 15. Therefore, the axial center position of each of the four connecting bolts 6 is held at a normal position.

In the battery module of (3), in each of the four connecting bolts 6, the intermediate small-diameter portion 73 has a diameter smaller than that of both the end side normal diameter portions 71 and 71. Therefore, the weight of the four connecting bolts 6 can be reduced.

While embodiments of the present invention have been described, the present invention is not limited thereto. The details of the configuration can be changed as appropriate within the effect of the present invention. For example, in order to pinch and hold a stacked body of a plurality of battery cells by end plates from both the end sides in the stacking direction, a configuration in which two end plates are connected using connecting bolts as connecting members is adopted. However, the connecting member is not limited to a connecting bolt. A configuration using another suitable longitudinal member can also be adopted.

### EXPLANATION OF REFERENCE NUMERALS

1 battery module
2 battery cell
3 stacked body
4 first end plate
5 second end plate
6 connecting bolt
7 shaft portion
8 head portion
9 male threaded portion
10 nut
11, 12 pressure receiving portion
13 insertion hole
14 nut-side large diameter portion
15 (15a, 15b, 15c, 15d) detent mechanism part
16 head-side large diameter portion
17 head-side spigot joint portion
41 recessed portion
51 recessed portion
52 contact surface
61 first connecting bolt
62 second connecting bolt
63 third connecting bolt
64 fourth connecting bolt
81 cutout portion
H00, H11, H15, H16, H21, 825, H26 through hole
S1 facing surface facing stacked body
S2 opposite surface on the opposite side of stacked body

What is claimed is:

1. A battery module in which a stacked body of a plurality of battery cells is pinched and held by two end plates from both end sides in a stacking direction, the battery module comprising:
a rod-shaped connecting member applying tension in directions opposite to each other to the two end plates on both the end sides,
the rod-shaped connecting member including a fastening portion adjacent to one of the two end plates and including a detent mechanism part in a vicinity of the fastening portion.

2. The battery module according to claim 1, wherein one of the two end plates, which is away from the fastening portion of the rod-shaped connecting member, includes a spigot joint portion that is coaxial with the detent mechanism part.

3. The battery module according to claim 1, wherein the rod-shaped connecting member has a smaller diameter in an intermediate portion in a longitudinal direction than in an end portion.

4. The battery module according to claim 2, wherein the rod-shaped connecting member has a smaller diameter in an intermediate portion in a longitudinal direction than in an end portion.
